(19) United States
(12) Patent Application Publication
(10) Pub. No.: US 2025/0358586 A1
(43) Pub. Date: Nov. 20, 2025

(54) METHOD AND APPARATUS FOR INTER-EDGE DATA NETWORK BASED SERVICE CONTINUITY

(71) Applicant: LENOVO (SINGAPORE) PTE LTD., NEW TECH PARK (TW)

(72) Inventor: ROOZBEH ATARIUS, LA JOLLA, CA (US)

(21) Appl. No.: 18/664,151

(22) Filed: May 14, 2024

(51) Int. Cl. H04W 4/021; H04W 28/02

(52) U.S. Cl. CPC H04W 4/021; H04W 28/0226

(57) ABSTRACT

Various aspects of the present disclosure relate to wireless communication continuity of vertical application layer (VAL) service to a device during inter-edge data network (EDN) mobility. A first network entity includes processor(s) coupled with at least one memory. In response to a mobility of a device indicating impending transfer from a source to a target EDN, the processor(s) are configured to cause the first network entity to identify a first network slice associated with the source EDN. The first network slice supports a VAL service for the device. The processor(s) determines a second network slice associated with the target EDN and capable of supporting the VAL service for the device. The processor(s) configures the first network entity to communicate, to the device, according to a hypertext markup transfer protocol using a custom notify method, a slice configuration associated with the second network slice to maintain continuity of the VAL service.

### TECHNICAL FIELD

The present disclosure relates to wireless communications, and more specifically service continuity for wireless communication mobility.

### BACKGROUND

A wireless communications system may include one or multiple network communication devices, such as base stations, that may support wireless communications for one or multiple user communication devices, which are also called user equipment (UE) or other suitable terminology. The wireless communications system may support wireless communications with one or multiple user communication devices by utilizing resources of the wireless communications system, including time resources (e.g., symbols, slots, subframes, frames, or the like) or frequency resources (e.g., subcarriers, carriers, or the like). Additionally, the wireless communications system may support wireless communications across various radio access technologies, such as including third generation (3G) radio access technology, fourth generation (4G) radio access technology, fifth generation (5G) radio access technology, and other suitable radio access technologies beyond 5G (e.g., sixth generation (6G)).

### SUMMARY

Some implementations of the method and apparatuses described herein may include a network entity that supports inter-edge data network (EDN) mobility of a device with continuity of a vertical application layer (VAL) service using a custom method of notifying the device of a slice configuration. In one or more embodiments, a first network entity for wireless communication includes at least one memory and at least one processor coupled with the at least one memory. In response to a mobility of a device indicates impending transfer from a source EDN service area to a target EDN service area, the at least one processor is configured to cause the first network entity to identify a first network slice associated with the source EDN service area, where the first network slice supports a VAL service for the device. The at least one processor is configured to cause the first network entity to determine a second network slice associated with the target EDN service area, where the second network slice is capable of supporting the VAL service for the device. The at least one processor is configured to cause the first network entity to communicate, to the device, according to a hypertext markup transfer protocol using a custom notify method, a slice configuration associated with the second network slice to maintain a continuity of the VAL service for the device.

In one or more embodiments, a processor includes at least one controller coupled with at least one memory. In response to a mobility of a device indicating an impending transfer from a source EDN service area to a target EDN service area, the at least one controller is configured to cause the processor to identify a first network slice associated with the source EDN service area. The first network slice supports a VAL service for the device. The at least one controller is configured to cause the processor to determine a second network slice associated with the target EDN service area, where the second network slice is capable of supporting the VAL service for the device. The at least one controller is configured to cause the processor to communicate, to the device, according to a hypertext markup transfer protocol using a custom notify method, a slice configuration associated with the second network slice to maintain a continuity of the VAL service for the device.

In some implementations of the method and apparatuses described herein, a device for wireless communication receives continuity of a VAL service during device mobility prompting or triggering transfer between EDN service areas. In one or more embodiments, the device includes at least one memory and includes at least one processor coupled with the at least one memory. The at least one processor is configured to cause the device to communicate with a source EDN service area to receive, from a first network entity, a VAL service supported by a first network slice. The at least one processor is configured to cause the device to receive, from the first network entity according to a hypertext markup transfer protocol using a custom notify method, a slice configuration associated with a second network slice to maintain continuity of the VAL service for the device. When the slice configuration is successfully received by the device, the at least one processor is configured to cause the device to communicate a no content status code indicating the success to the first network entity and to perform a transfer to a target EDN service area. The at least one processor is configured to cause the device to communicate with the target EDN service area using the slice configuration of the second network slice to receive the VAL service supported by the second network slice.

As utilized herein, an article “a” before an element is unrestricted and understood to refer to “at least one” of those elements or “one or more” of those elements. The terms “a,” “at least one,” “one or more,” and “at least one of one or more” may be interchangeable. As used herein, including in the claims, “or” as used in a list of items (e.g., a list of items prefaced by a phrase such as “at least one of” or “one or more of” or “one or both of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on. Further, as used herein, including in the claims, a “set” may include one or more elements.

### BRIEF DESCRIPTION OF THE DRAWINGS

FIG. 1 illustrates an example of a wireless communications system that supports continuity of a vertical application layer (VAL) service for a device during mobility indicates impending transfer between Edge Data Network (EDN) service areas in accordance with aspects of the present disclosure.

FIG. 2 is a communications diagram of predictive inter-EDN slice service continuity supported by a communication environment in accordance with aspects of the present disclosure.

FIG. 3 illustrates a communication diagram of a procedure for notification of inter-EDN slice information in a communication environment in accordance with aspects of the present disclosure.

FIG. 4 illustrates a resource Uniform Resource Indicator (URI) structure diagram of a first embodiment Application Program Interface (API) in accordance with aspects of the present disclosure.

FIGS. 5A-5B (collectively “FIG. 5”) are example program code for the first embodiment API that includes the custom method for notification of inter-EDN slice information in accordance with aspects of the present disclosure.

FIG. 6 illustrates a resource URI structure diagram of a second embodiment API in accordance with aspects of the present disclosure.

FIGS. 7A-7K (collectively “FIG. 7”) are example program code for the second embodiment API that includes the custom method for notification of inter-EDN slice information in addition to supporting the other Inter-EDN continuity features in accordance with aspects of the present disclosure.

FIG. 8 illustrates an example of a network entity that supports predictive inter-EDN service area slice service continuity including VAL service for a device in accordance with aspects of the present disclosure.

FIG. 9 illustrates an example of a processor that supports predictive inter-EDN slice service continuity including VAL service for a device in accordance with aspects of the present disclosure.

FIG. 10 illustrates an example of a device that receives continuity of a VAL service during device mobility indicating impending transfer between EDN service areas in accordance with aspects of the present disclosure.

FIG. 11 illustrates a flowchart of a method for wireless communication at a network entity that supports predictive inter-EDN slice service continuity including VAL service for a device in accordance with aspects of the present disclosure.

FIG. 12 illustrates a flowchart of a method for wireless communication at a device that receives continuity of a VAL service during device mobility indicating impending transfer between EDN service areas in accordance with aspects of the present disclosure.

### DETAILED DESCRIPTION

The Fifth Generation (5G) system introduces optimized support for a variety of different communication services, different traffic loads, and different end user communities. For example, the communication services using network slicing may include Vehicle to Everything (V2X) services, 5G seamless enhanced Mobile Broadband (eMBB) service with Fixed-Mobile Convergence (FMC) and massive Internet of Things (IoT) connections. A network slice is a logical network that provides specific network capabilities and network characteristics, supporting various service properties for network slice customers. Communication services may be supported by one or a combination of network slices. Network slices are generally composed of network slice subnets (e.g. radio access network (RAN) network slice subnet, core network slice subnet, and transport network slice subnet. Network slice subnets are composed of Network Functions (NF). Network functions may be realized via combination of Virtualized Network Functions (VNF) and/or Physical Network Functions (PNF). A variety of communication services may be provided by one or multiple network slice(s).

Service Enabler Architecture Layer (SEAL) supports easier and faster development and deployment of vertical applications (“apps”) for auxiliary services, such as location management across multiple vertical apps. SEAL architecture enables common services to be consumed by vertical apps over 3GPP, common application interface framework (CAPIF) compliant, northbound APIs. SEAL architecture supports two functional models: on-network (i.e., SEAL-Uu), when the user equipment (UE) connects to the 3GPP network system to consume the service; and off-network (i.e., SEAL-PC5), when UEs connect to each other directly. In one or more embodiments, the main functional entities of SEAL architecture are the following:
(i) Vertical Application Layer Client (VAL client) is an entity that provides the client-side functionalities of the corresponding vertical app (e.g., Vehicle to Everything (V2X) client).
(ii) Vertical Application Layer Server (VAL server) is an entity that provides the server-side functionalities of the corresponding vertical app (e.g., V2X application server). If CAPIF is supported, VAL server acts as an application exposing function (AEF) to provide the service APIs to the Vertical Application Server (VAS) or another VAE server. The VAL server acts as an API invoker to consume the service APIs provided by another VAL server.
(iii) SEAL client is an entity that provides the client-side functionalities corresponding to a specific SEAL service (e.g., Location Management client).
(iv) SEAL server is an entity that provides the server-side functionalities corresponding to a specific SEAL service (e.g., Location Management server) and can act as a CAPIF API exposing function.

Various deployment scenarios may be implemented using a SEAL architecture, such as a single Public-Land Mobile Network (PLMN) operator domain (centralized deployment) or in multiple PLMN operator domains, as a distributed function, with or without interconnection between the SEAL servers. In addition, implementations of SEAL architecture may be implemented within the VAL service provider domain or within a separate SEAL provider domain.

According to aspects of the present disclosure, the features of VAL services are supported by Edge Data Networks (EDNs). Edge computing by an EDN addresses problems of data latency by having core network and cloud computing capabilities moved to an “edge” of a network, closer to customers. The physical distance of communications is reduced, which thus reduces data latency. Edge computing by an EDN may also enhance security and data protection by keeping data at an edge of the network, perhaps within customer premises. An EDN may offer reliability and resiliency features by limiting vulnerable communication connections and physical access.

SEAL Network Slice Capability Enablement (SNSCE), as an interface between the SNSCE server and SNSCE client for predictive slice modification in Inter-EDN based slice service continuity, was conventionally expected to be based on the SNSCE client subscribing to the SNSCE server by using an event. However, a stage 2 description currently does not list any subscription and the event is not specified. Therefore, a need exists for a new method to be developed to implement the interface.

Aspects of the present disclosure provides for the interaction between the SNSCE server and the SNSCE client during device mobility indicating impending transfer between EDNs by means of a custom operation, where the source SNSCE server notifies the SNCSE client without any need for subscription. The target EDN service area is supported by a target SNSCE server. The custom operation does not break stage 2 requirements by allowing the SNSCE server to use the hypertext markup transfer protocol (HTTP) “POST” request to notify the SNSCE client of the network slice information. In computing, POST is a request method supported by HTTP used by the World Wide Web. By design, the POST request method requests that a web server accepts the data enclosed in the body of the request message, most likely for storing the data. The slice information is required for the VAL service continuity in the target EDN service area during the inter-EDN mobility. The notify procedure is based on HTTP POST request with an appropriate path defining the custom operation.

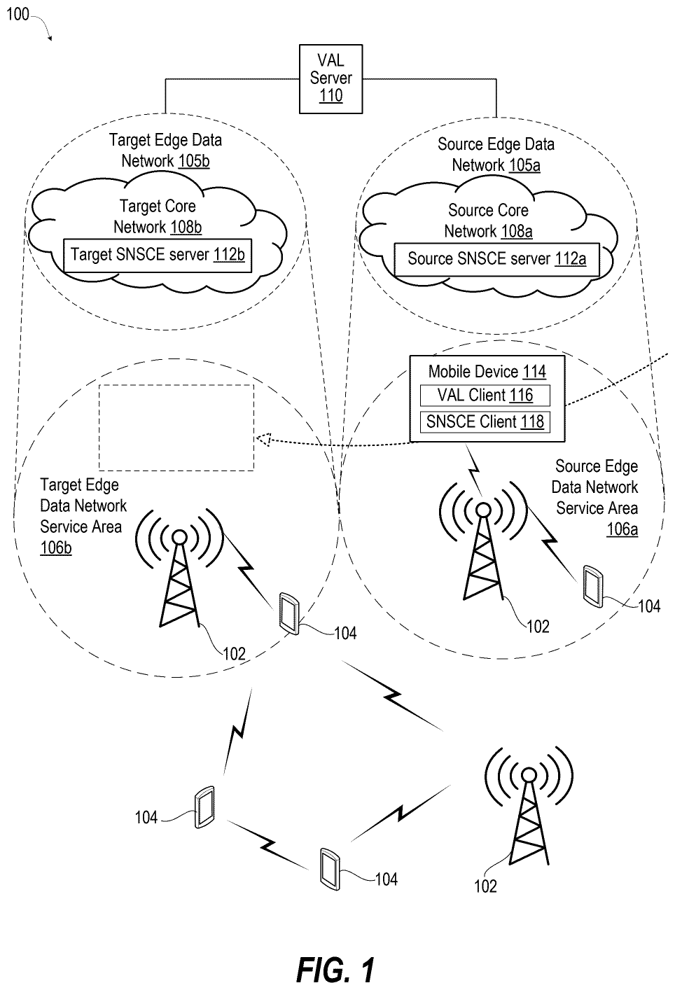

FIG. 1 illustrates an example of a wireless communications system 100 that supports continuity of a vertical application layer (VAL) service for a device during mobility between EDN service areas, in accordance with aspects of the present disclosure. Communications system 100 may include wireless communications between network devices such as base stations 102 and devices such as user equipment (UE) 104. Communications system 100 may include network entities such as a source Edge Data Network (EDN) 105a having base station(s) 102 that support a source EDN service area 106a. Source core network 108a provides backend support to source EDN service area 106a. In an example, communications system 100 may include network entities such as a target EDN 105b having base station(s) 102 that support a target EDN service area 106a. Target core network 108b provides backend support to target EDN service area 106b. The wireless communications system 100 may include one or more other network entities such as a Vertical Application Layer (VAL) server 110 that provides a VAL service to both EDN service areas 106a and 106b. Source EDN service area 106a is supported by a source SNSCE server 112a. Target EDN service area 106b is supported by a target SNSCE server 112b. Source and target SNSCE servers 112a and 112b negotiate to provide continuity of the VAL service during device mobility that indicates impending transfer between the source and target EDN service areas 106a and 106b. Devices of the communications system 100 further include mobile devices 114 that each includes VAL client 116 that communicates, via a base station 102 and a connected one of source and target EDN service areas 106a and 106b, to receive the VAL service from VAL server 110. Mobile device 114 also includes SNSCE client 118 that communicates, via a base station 102 and via a connected one of the source and target EDN service areas 106a and 106b, to the corresponding one of the source and target SNSCE servers 112a and 112b. In particular, the SNSCE client 118 receives a configuration of a network slice that supports the VAL service for continuity of receiving the VAL service during inter-EDN mobility. In an example, mobile device 114 may physically move from a source EDN service area 106a of source EDN 105a to the target EDN service area 106b of target EDN 105b. The description below for communications by UEs 104 is applicable to the mobile devices 114.

The wireless communications system 100 may support various radio access technologies. In some implementations, the wireless communications system 100 may be a fourth generation (4G) network, such as an LTE network or an LTE-Advanced (LTE-A) network. In some other implementations, the wireless communications system 100 may be a new radio (NR) network, such as a fifth generation (5G) network, a 5G-Advanced (5G-A) network, or a 5G ultrawideband (5G-UWB) network. In other implementations, the wireless communications system 100 may be a combination of a 4G network and a 5G network, or other suitable radio access technology including Institute of Electrical and Electronics Engineers (IEEE) 802.11 (Wi-Fi), IEEE 802.16 (WiMAX), and IEEE 802.20. The wireless communications system 100 may support radio access technologies beyond 5G, for example, 6G. Additionally, the wireless communications system 100 may support different technologies, such as time division multiple access (TDMA), frequency division multiple access (FDMA), or code division multiple access (CDMA), etc.

The one or more base station 102 may be dispersed throughout a geographic region to form the wireless communications system 100. One or more of the base station 102 described herein may be, or may include, or may be referred to as a network node, a base station, a network element, a network function, a network equipment, a network entity, a radio access network (RAN), a NodeB, an eNodeB (eNB), a next-generation NodeB (gNB), or other suitable terminology. A base station 102 and a UE 104 may communicate via a communication link, which may be a wireless or wired connection. For example, a base station 102 and a UE 104 may perform wireless communication (e.g., receive signaling, transmit signaling) over a Uu interface.

A base station 102 may provide a geographic coverage area for which the base station 102 may support services for one or more UEs 104 within the geographic coverage area. For example, a base station 102 and a UE 104 may support wireless communication of signals related to services (e.g., voice, video, packet data, messaging, broadcast, etc.) according to one or multiple radio access technologies. In some implementations, a base station 102 may be moveable, for example, a satellite associated with a non-terrestrial network (NTN). In some implementations, different geographic coverage areas associated with the same or different radio access technologies may overlap, but the different geographic coverage areas may be associated with different base stations 102.

The one or more UE 104 may be dispersed throughout a geographic region of the wireless communications system 100. A UE 104 may include or may be referred to as a remote unit, a mobile device, a wireless device, a remote device, a subscriber device, a transmitter device, a receiver device, or some other suitable terminology. In some implementations, the UE 104 may be referred to as a unit, a station, a terminal, or a client, among other examples. Additionally, or alternatively, the UE 104 may be referred to as an Internet-of-Things (IoT) device, an Internet-of-Everything (IoE) device, or machine-type communication (MTC) device, among other examples.

A UE 104 may be able to support wireless communication directly with other UEs 104 over a communication link. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link may be referred to as a sidelink. For example, a UE 104 may support wireless communication directly with another UE 104 over a PC5 interface.

A base station 102 may support communications with at least one of the CNs 108a and 108b, or with another base station 102, or both. For example, a base station 102 may interface with other base station 102 or at least one of the CNs 108a and 108b through one or more backhaul links (e.g., S1, N2, N2, or network interface). In some implementations, the base stations 102 may communicate with each other directly. In some other implementations, the base stations 102 may communicate with each other or indirectly (e.g., via the CN 108a). In some implementations, one or more base station 102 may include subcomponents, such as an access network entity, which may be an example of an access node controller (ANC). An ANC may communicate with the one or more UEs 104 through one or more other access network transmission entities, which may be referred to as radio heads, smart radio heads, or transmission-reception points (TRPs).

Each CN 108a and 108b may support user authentication, access authorization, tracking, connectivity, and other access, routing, or mobility functions. Each CN 108a and 108b may be an evolved packet core (EPC), or a 5G core (5GC), which may include a control plane entity that manages access and mobility (e.g., a mobility management entity (MME) and/or an access and mobility management functions (AMF)) and a user plane entity that routes packets or interconnects to external networks (e.g., a serving gateway (S-GW), a Packet Data Network (PDN) gateway (P-GW), or a user plane function (UPF)). In some implementations, the control plane entity may manage non-access stratum (NAS) functions, such as mobility, authentication, and bearer management (e.g., data bearers, signal bearers, etc.) for the one or more UEs 104 served by the one or more base station 102 associated with one of the CNs 108a and 108b.

Each CN 108a and 108b may communicate with a packet data network over one or more backhaul links (e.g., via an S1, N2, N2, or another network interface). The packet data network may include an application server. In some implementations, one or more UEs 104 may communicate with the application server. A UE 104 may establish a session (e.g., a protocol data unit (PDU) session, or the like) with one of the CN 108a and 108b via a base station 102. Each CN 108a and 108b may route traffic (e.g., control information, data, and the like) between the UE 104 and the application server using the established session (e.g., the established PDU session). The PDU session may be an example of a logical connection between the UE 104 and one of the CNs 108a and 108b (e.g., one or more network functions of the CNs 108a and 108b).

In the wireless communications system 100, the base stations 102 and the UEs 104 may use resources of the wireless communications system 100, including time resources (e.g., symbols, slots, subframes, frames, or the like) or frequency resources (e.g., subcarriers, carriers) to perform various operations (e.g., wireless communications). In some implementations, the base stations 102 and the UEs 104 may support different resource structures. For example, the base stations 102 and the UEs 104 may support different frame structures. In some implementations, such as in 4G, the base stations 102 and the UEs 104 may support a single frame structure. In some other implementations, such as in 5G and among other suitable radio access technologies, the base stations 102 and the UEs 104 may support various frame structures (i.e., multiple frame structures). The base stations 102 and the UEs 104 may support various frame structures based on one or more numerologies.

One or more numerologies may be supported in the wireless communications system 100, and a numerology may include a subcarrier spacing and a cyclic prefix. A first numerology (e.g., μ=0) may be associated with a first subcarrier spacing (e.g., 15 kHz) and a normal cyclic prefix. In some implementations, the first numerology (e.g., μ=0) associated with the first subcarrier spacing (e.g., 15 kHz) may utilize one slot per subframe. A second numerology (e.g., μ=1) may be associated with a second subcarrier spacing (e.g., 30 kHz) and a normal cyclic prefix. A third numerology (e.g., μ=2) may be associated with a third subcarrier spacing (e.g., 60 kHz) and a normal cyclic prefix or an extended cyclic prefix. A fourth numerology (e.g., μ=3) may be associated with a fourth subcarrier spacing (e.g., 120 kHz) and a normal cyclic prefix. A fifth numerology (e.g., μ=4) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally, or alternatively, a time interval of a resource (e.g., a communication resource) may be organized according to slots. For example, a subframe may include a number (e.g., quantity) of slots. The number of slots in each subframe may also depend on the one or more numerologies supported in the wireless communications system 100. For instance, the first, second, third, fourth, and fifth numerologies (i.e., μ=0, μ=1, μ=2, μ=3, μ=4) associated with respective subcarrier spacings of 15 kHz, 30 kHz, 60 kHz, 120 kHz, and 240 kHz may utilize a single slot per subframe, two slots per subframe, four slots per subframe, eight slots per subframe, and 16 slots per subframe, respectively. Each slot may include a number (e.g., quantity) of symbols (e.g., OFDM symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (410 MHz-7.125 GHz), FR2 (24.25 GHz-52.6 GHz), FR3 (7.125 GHz-24.25 GHz), FR4 (52.6 GHz-114.25 GHz), FR4a or FR4-1 (52.6 GHZ-71 GHz), and FR5 (114.25 GHz-300 GHz). In some implementations, the base stations 102 and the UEs 104 may perform wireless communications over one or more of the operating frequency bands. In some implementations, FR1 may be used by the base stations 102 and the UEs 104, among other equipment or devices for cellular communications traffic (e.g., control information, data). In some implementations, FR2 may be used by the base stations 102 and the UEs 104, among other equipment or devices for short-range, high data rate capabilities.

FR1 may be associated with one or multiple numerologies (e.g., at least three numerologies). For example, FR1 may be associated with a first numerology (e.g., μ=0), which includes 15 kHz subcarrier spacing, a second numerology (e.g., μ=1), which includes 30 kHz subcarrier spacing, and a third numerology (e.g., μ=2), which includes 60 kHz subcarrier spacing. FR2 may be associated with one or multiple numerologies (e.g., at least 2 numerologies). For example, FR2 may be associated with a third numerology (e.g., μ=2), which includes 60 kHz subcarrier spacing, and a fourth numerology (e.g., μ=3), which includes 120 kHz subcarrier spacing.

In one or more embodiments, during client mobility indicating impending transfer between the source EDN service area 106a and the target EDN service area 106b, the present disclosure resolves the interaction between the source SNSCE server 112a and the SNSCE client 118 by means other than subscription and notification. In particular, the present disclosure is based on a custom service operation that allows the source SNSCE server 112a to negotiate with the target SNSCE server 112b and to then use the HTTP POST request to notify the SNSCE client 118 of the network slice information that is required for the VAL service continuity in the target SNSCE service area 106b during the inter-EDN mobility.

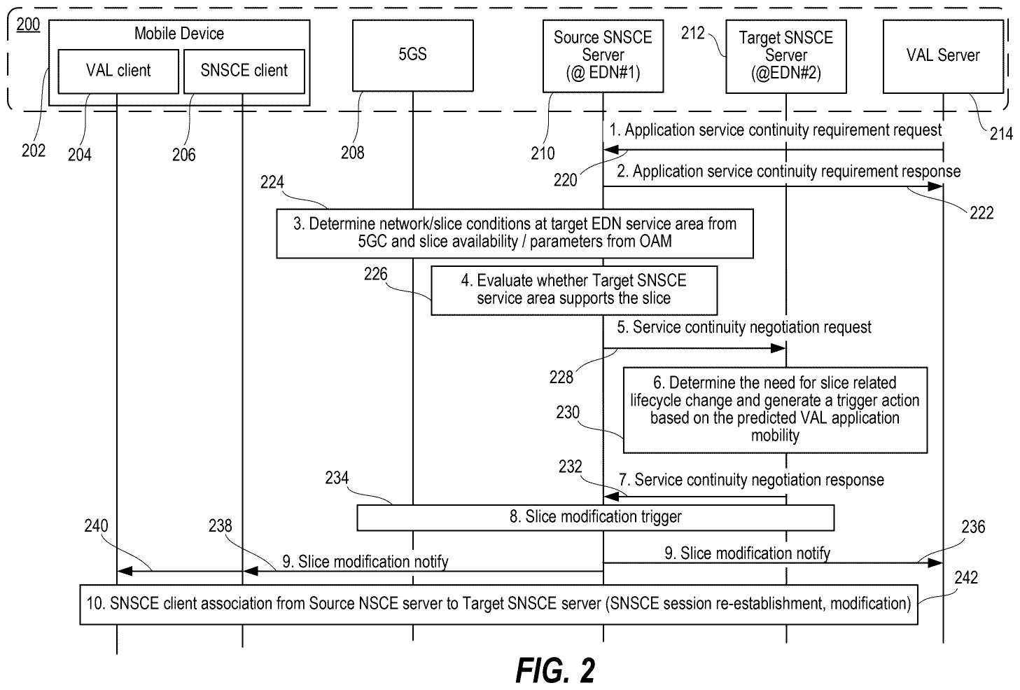

FIG. 2 is a communications diagram of predictive inter-EDN slice service continuity supported by a communication environment 200 that includes mobile device 202, a mobile network such as a Fifth Generation System (5GS) 208, a first network entity such as a source SNSCE server 210, a second network entity such as a target SNSCE server 212b, and a VAL server 214. Source SNSCE server 210 is at a first EDN (“@ EDN #1”) such as source EDN 105a (FIG. 1). Target SNSCE server 212b is at a second EDN (“@ EDN #2”) such as target EDN 105b (FIG. 1). Device 202 includes/supports VAL client 204 and SNSCE client 206. For predictive inter-EDN slice service continuity, the present disclosure defines a first interface between the SNSCE server 212 and the VAL server 214. The present disclosure defines a second interface between the SNSCE server 212 and the SNSCE client 206. A mechanism is provided to allow for slice modification when a vertical application of single or group of VAL devices, such as mobile device 202, migrates (or is expected/predicted to migrate) to a different EDN supported by a different one of SNSCE server 212a or 212b.

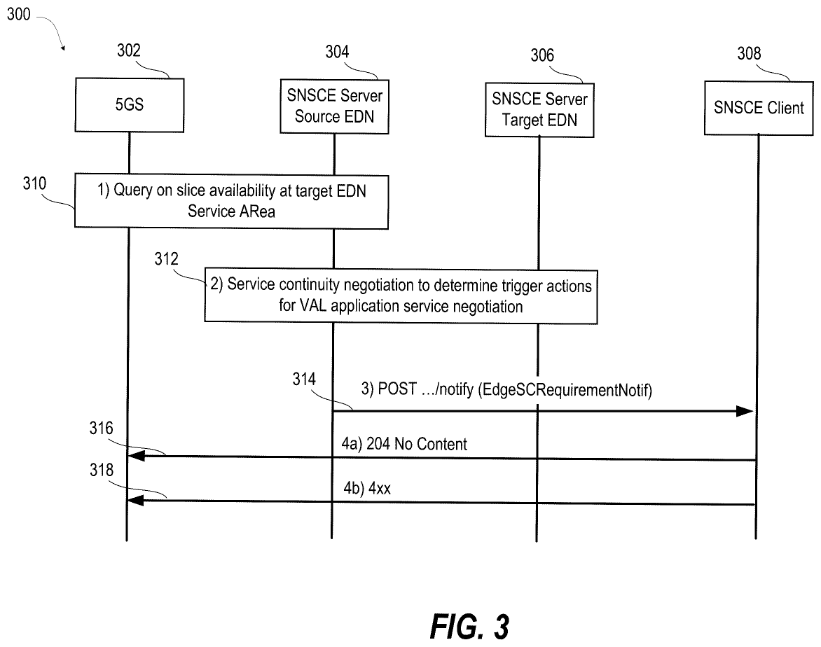

Arrows in FIGS. 2 and 3 denote one-way communications. Boxes that intersection a vertical time axis from only one entity in FIG. 2 denote processing at the one entity. Boxes that cross vertical axes below two or more entities denote a communication exchange between the outermost entities. With continued reference to FIG. 2, at 220, the VAL server 214 communicates an application service continuity requirement request to the source SNSCE server 210. At 222, the source SNSCE server 210 communicates an application service continuity requirement response to the VAL server 214. At block 224, the source SNSCE server 210 queries 5GS 208 to determine network/slice destination network/slice conditions at the target EDN service area supported by target SNSCE server 212 and queries Operations, Management, and Administration (OAM) to determine slice availability/parameters. At block 226, the source SNSCE server 210 evaluates whether the target SNSCE service area supports the slice. At 228, the source SNSCE server 210 communicates a serve continuity negotiation request with the target SNSCE server 212. At block 230, the target SNSCE server 212 determines the need for slice related lifecycle change and generates a trigger action based on the predicted VAL application mobility. At 232, the target SNSCE server 212 communicates a service continuity negotiation response to the source SNSCE server 210. At block 234, the source SNSCE server 210 and the target SNSCE server 212 generate a slice modification trigger. At 236, the source SNSCE server 212 communicates a slice modification notification to the VAL server 214. At 238, the source SNSCE server 210 communicates a slice modification notification to the SNSCE client 206 of mobile device 202. At 240, the SNSCE client 206 relays the slice modification notification to the VAL client 204 of the mobile device 202. At block 242, the SNSCE client 204 and the target SNSCE server 212 perform SNSCE session re-establishment and modification by transferring the SNSCE client association from the source SNSCE server 210 to the target SNSCE server 212.

FIG. 3 illustrates a communication diagram of a procedure for notification of inter-EDN slice information in a communication environment 300 that includes 5GS 302, a source SNSCE server 304 in a source EDN service area, a target SNSCE server 306 in a target EDN service area, and a SNSCE client 308. This service operation is used by the SNSCE server 304, after negotiating with target SNSCE server 306, to notify the SNSCE client 308 of the slice network information to extend the VAL service continuity to the target EDN service area at the time of inter-EDN mobility. At block 310, source SNSCE server 304 queries 5GS 302 on slice availability at target EDN service area. At block 312, when the source SNSCE server 304 determines that a need exists for modification of the network slice for service continuity, the source SNSCE server 304 performs service continuity negotiation with target SNSCE server 306 to determine trigger actions for VAL application service negotiation. At 314, source SNSCE server 304 executes POST method including/notify (EdgeSCRequirementNotif) to communicate with SNSCE client 308. In one or more embodiments, to notify the SNSCE client 308 of the inter-EDN network slice information, which is to be used to extend the VAL service continuity in the target EDN service area during the inter-EDN mobility, the source SNSCE server 304 executes an HTTP POST request to the SNSCE client 308 targeting the uniform resource indicator (URI) of the “Notify” custom operation, with the request body containing the “EDGESCRequirementNotif” data structure as specified. At 316, if SNSCE client 308 successfully received the slice configuration, SNSCE client 308 communicates 204 no content to the source SNSCE server 304. At 318, if SNSCE client 308 unsuccessfully received (i.e., failure) the slice configuration, SNSCE client 308 communicates a status code 4xx to the source SNSCE server 304.

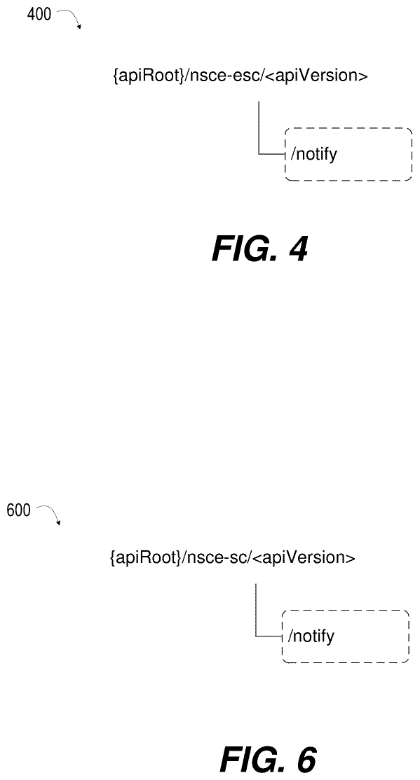

Implementation of aspects of the present disclosure may be accomplished via Inter-EDN service continuity Application Program Interfaces (APIs). FIG. 4 illustrates a resource URIs structure diagram of a first embodiment “NSCE_NSCE_EdnSliceInfo” API 400. In this embodiment, a new API is created for the purpose of the SNSCE server to notify the SNSCE client of the network slice information to extend the slice availability for the VAL service continuity in the target EDN service area if the SNSCE client is expected to move to the target EDN service area from the source EDN service area due to mobility. The “NSCE EdnSliceInfo” service uses the NSCE_EdnSliceInfo API. The API URI of the NSCE_EdnSliceInfo API has the resource URI structure:

{apiRoot}/<apiName>/<apiVersion>/<apiSpecificSuffixes>
where:
a) {apiRoot} is set as specified;
b) <apiName> is “nsce-esc”;
c) <apiVersion> is “v1”; and
d) <apiSpecificSuffixes> is set as specified.

When using HTTP/1.1, NSCE_EdnSliceInfo API communicating over transport layer security (TLS) may be mandatory. When using HTTP/2, NSCE_EdnSlice Info API communicating over TLS may be recommended. A functional entity desiring to use HTTP/2 shall use the HTTP upgrade mechanism to negotiate applicable HTTP version. As for content type, the bodies of HTTP request and successful HTTP responses may be encoded in JavaScript Object Notation (JSON) format. The Multipurpose Internet Mail Extensions (MIME) media type that may be used within the related Content-Type header field is “application/json”.

The custom operations and applicable HTTP methods defined for the NSCE_EdnSliceInfo API includes custom operation name “notify” having custom operation URI “/notify” that is mapped HTTP method POST and having description of enabling the source SNSCE server to notify the SNSCE client of the new slice configuration. The URI variables for this custom operation include name apiRoot of data type string.

A data structure supported by the POST request body on this resource includes “EdgeSCRequirementNotif” having P: “M” and cardinality “1” and description of notification on slice modification information for service continuity of a VAL application in the target EDN service area. A data structure supported by the POST request body includes response codes 204 No Content with description of a successful case. Notification of the slice information was successfully received.

Data type “EdgeSCRequirementNotif” represents the slice information that is used and/or modified to extend slice availability to the target END service area. The slice information is sent to the VAL UEs that are impacted by the modification of the network slice. Thus, the related optional element “uelds” of the EdgeSCRequirementNotif data structure is not used when the EdgeSCRequirementNotif data structure is sent to the SNSCE client by the SNSCE server.

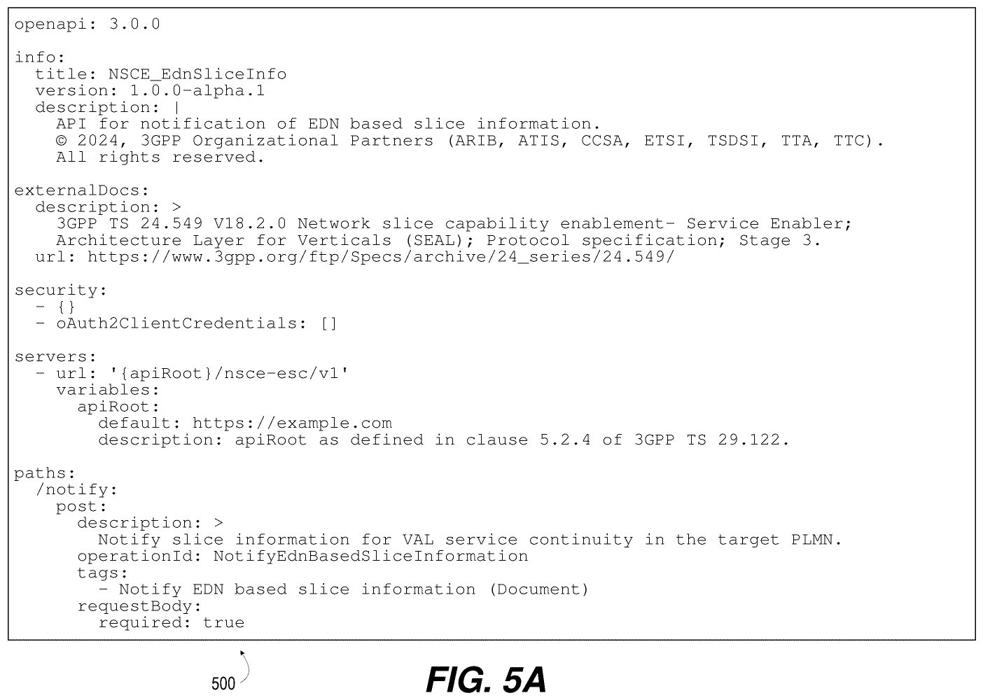

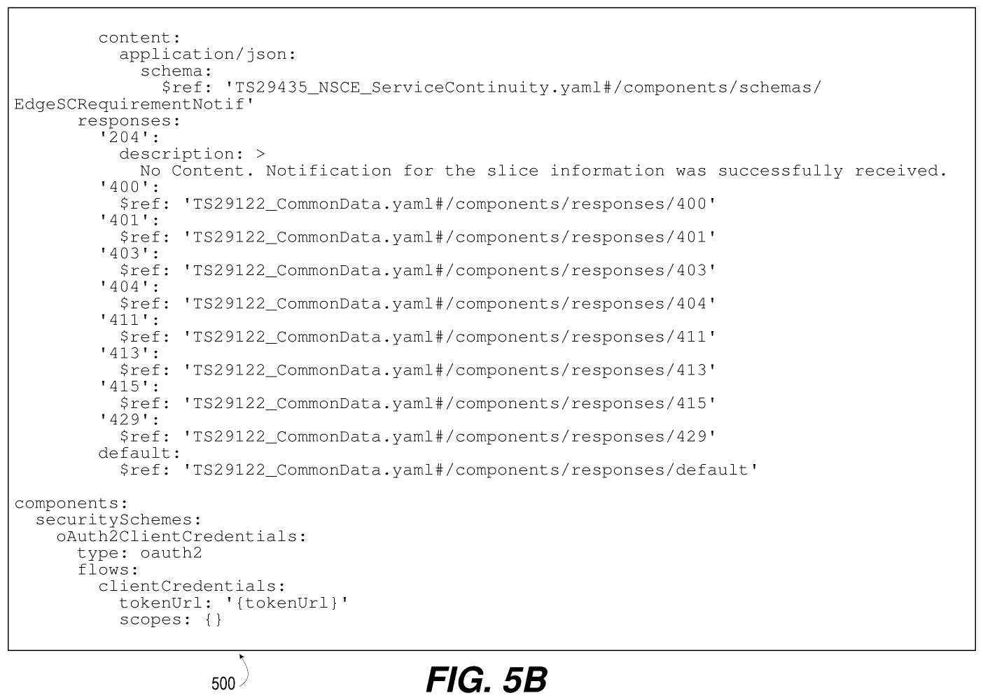

FIGS. 5A-5B (collectively “FIG. 5”) are example program code 500 for the NSCE_EdnSliceInfo API that includes the custom method for notification of inter EDN slice information.

FIG. 6 is a resource URIs structure diagram of a second embodiment “NSCE_ServiceContinuity” API 600, which is the same API that is used for the subscription to an event to the SNSCE server by the VAL server. “NSCE_ServiceContinuity” API 600 is extended to be used by the SNSCE server to notify the SNSCE client of the network slice information to extend the slice availability for the VAL service continuity in the target EDN service area during the inter-EDN mobility. In particular, the NSCE_ServiceSliceInfo service uses the NSCE_ServiceContinuity API 600. The structure of the custom operation URIs of the NSCE_ServiceContinuity API 600 is modified to add a new custom operation URI “/notify” as described above for FIGS. 4 and 5, enabling notification of slice modification information for service continuity of a VAL application in the target EDN service area.

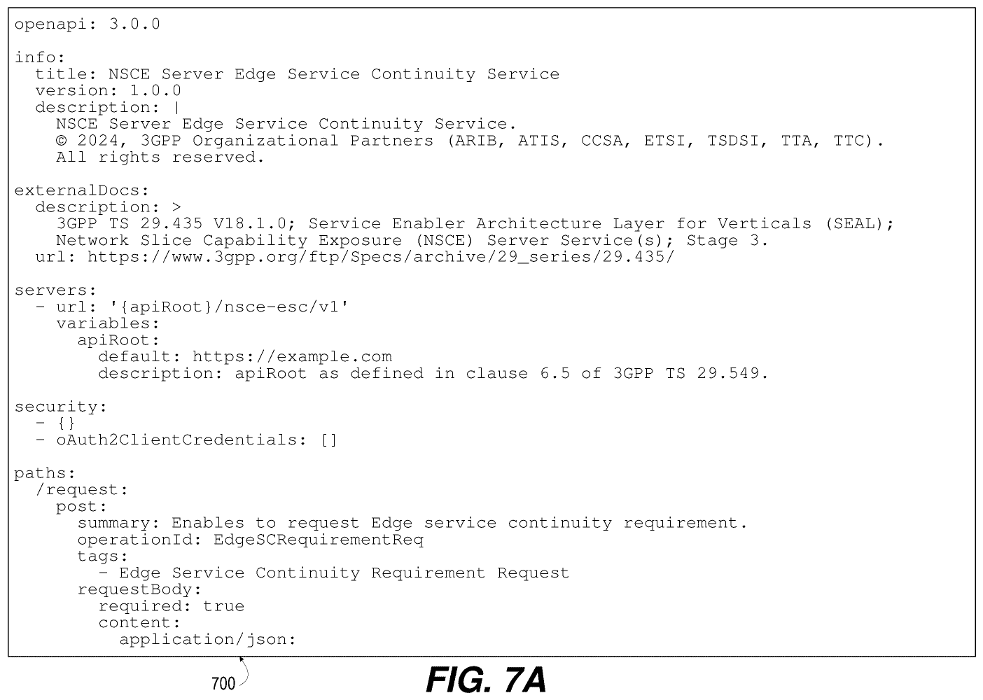

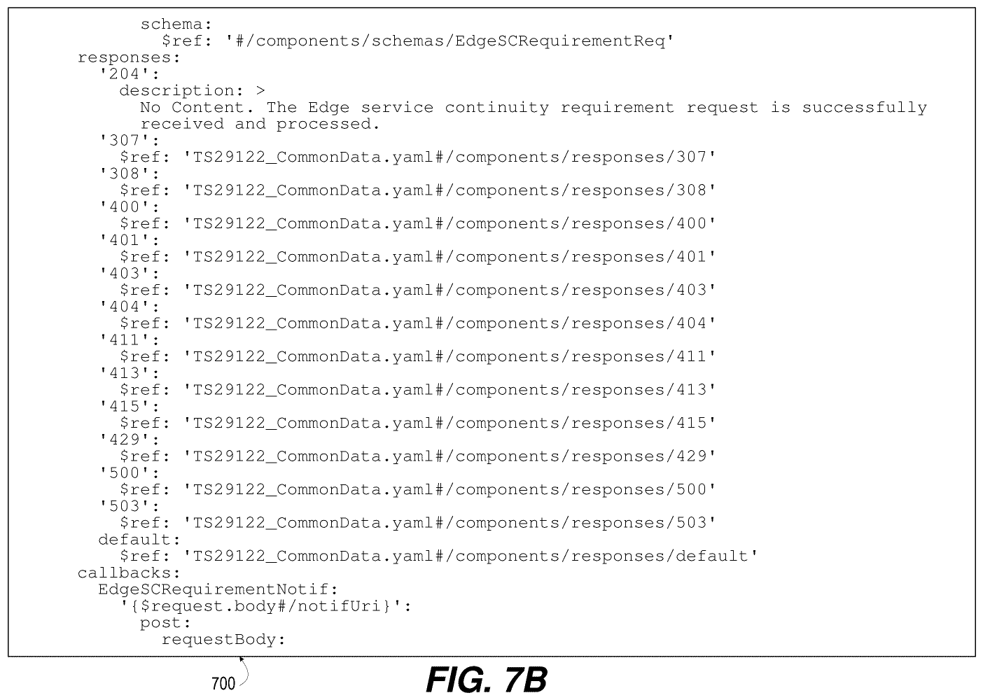

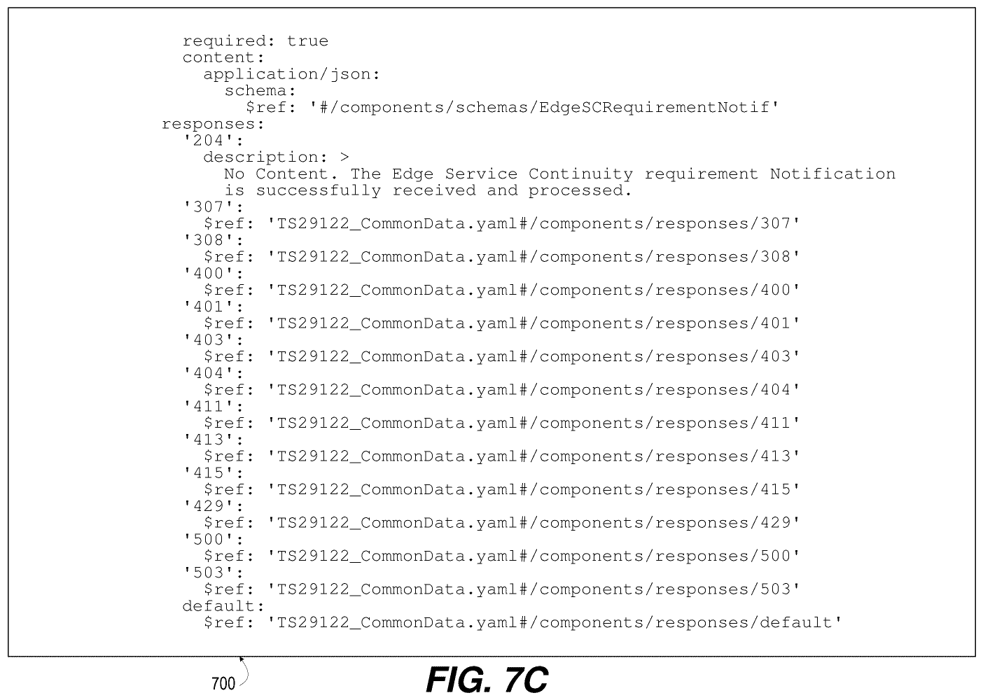

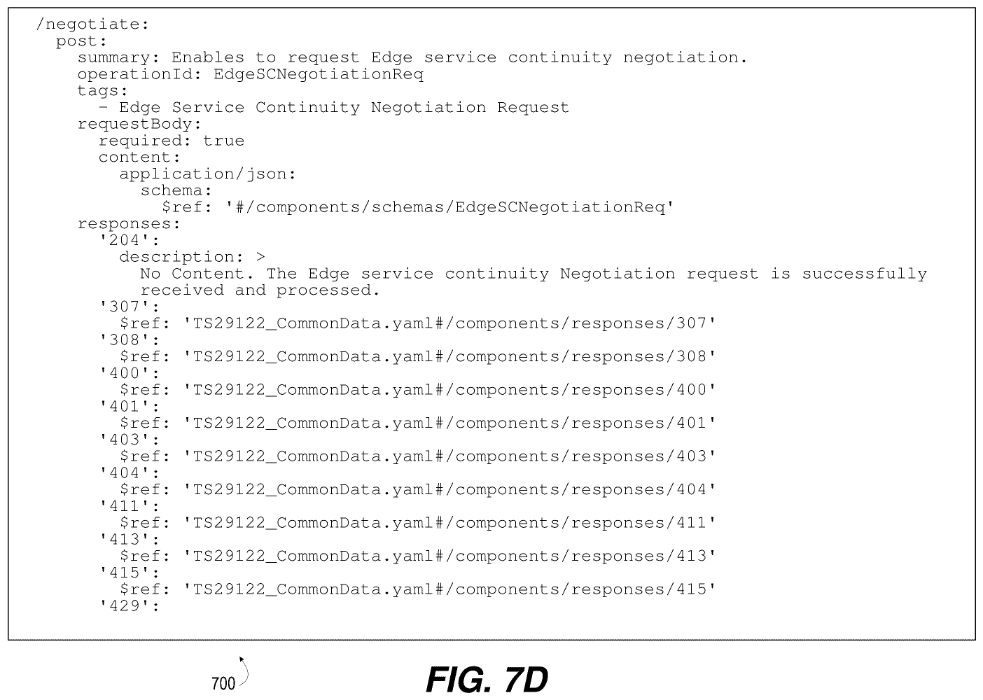

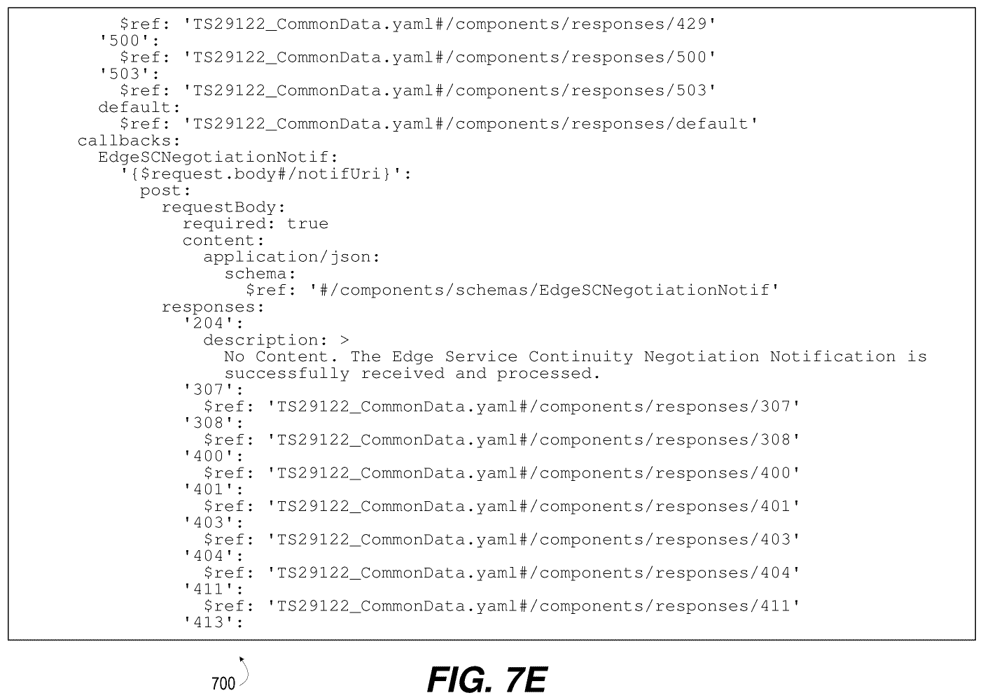

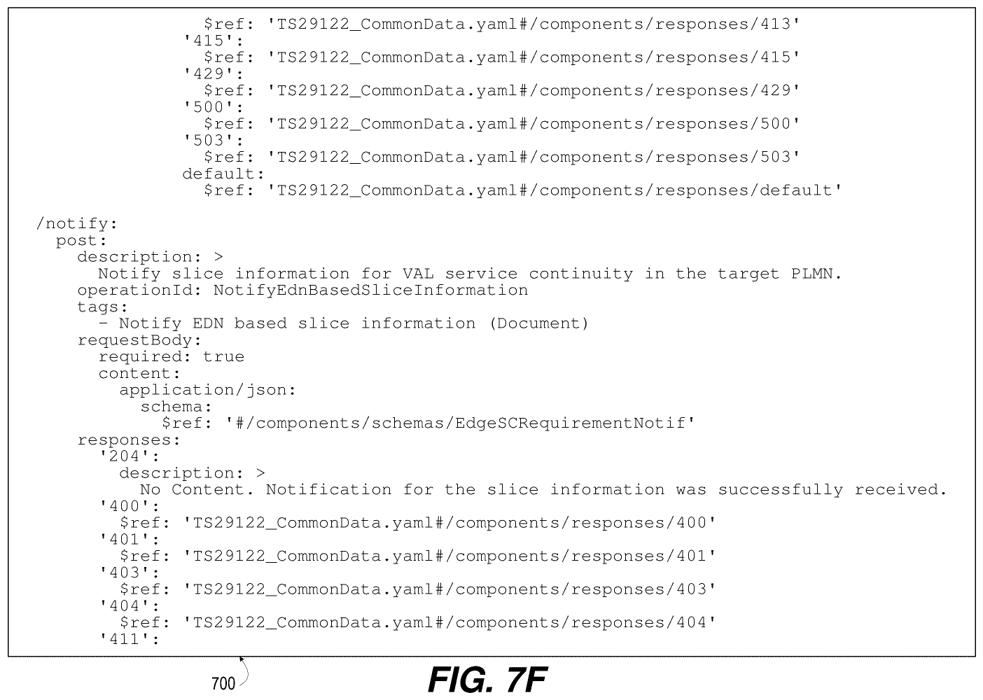

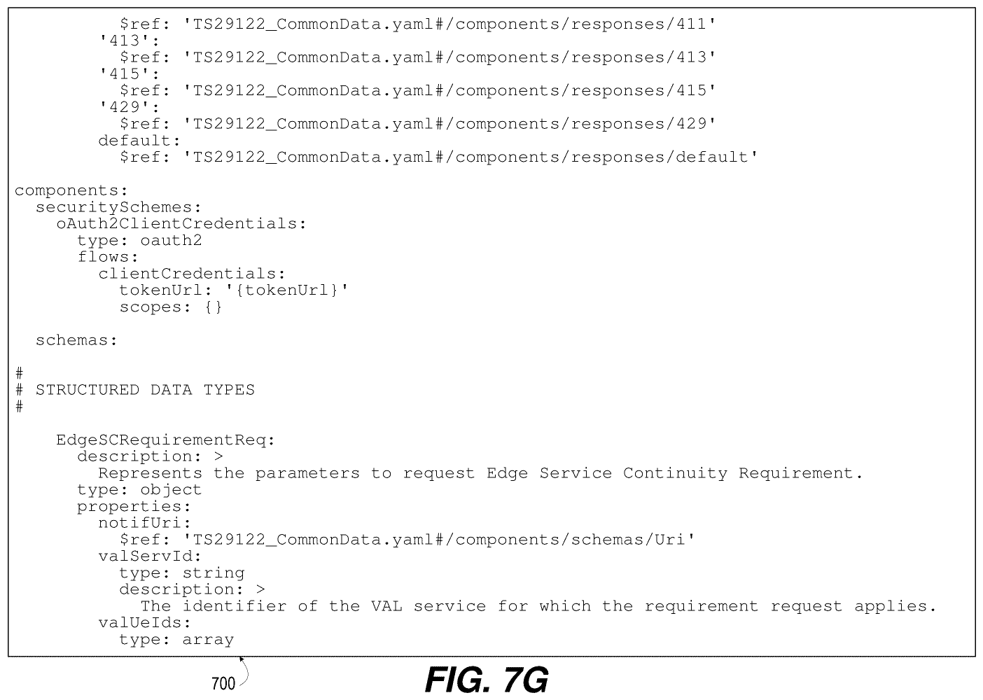

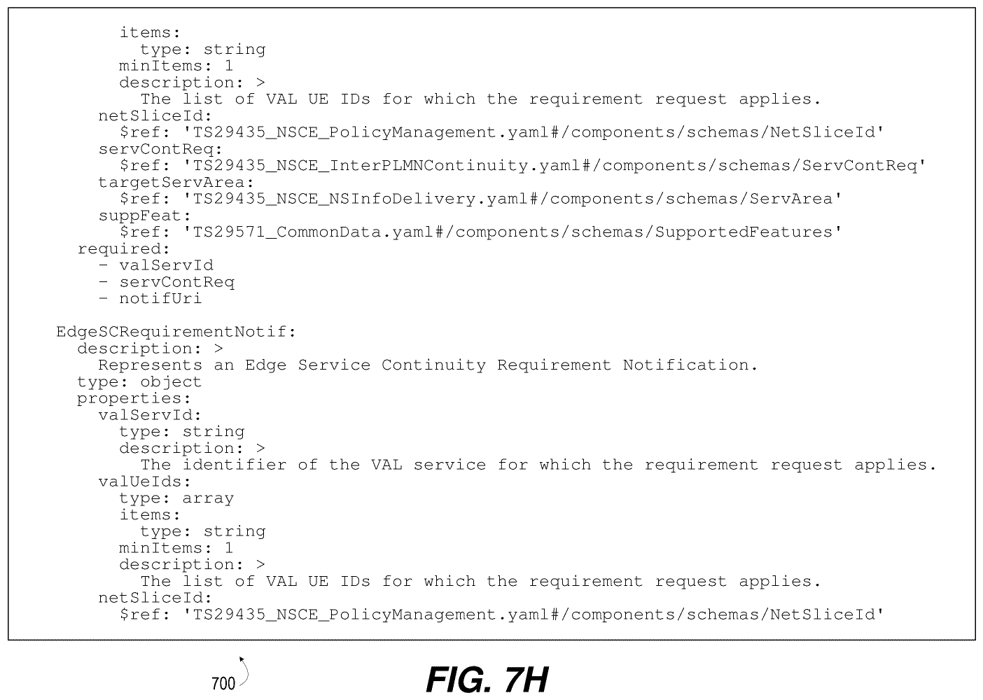

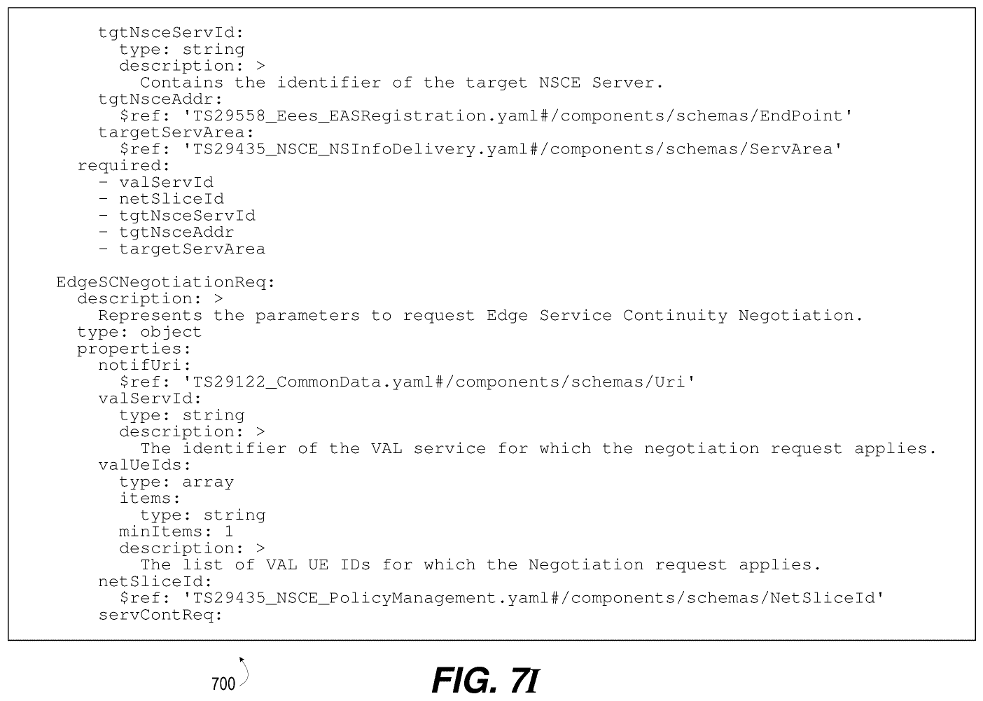

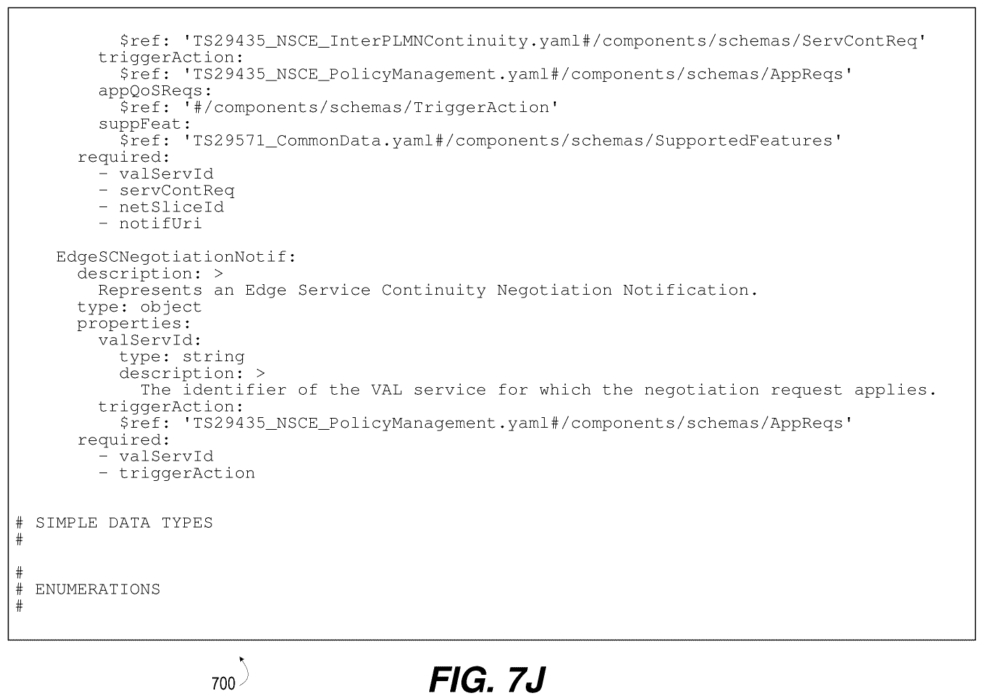

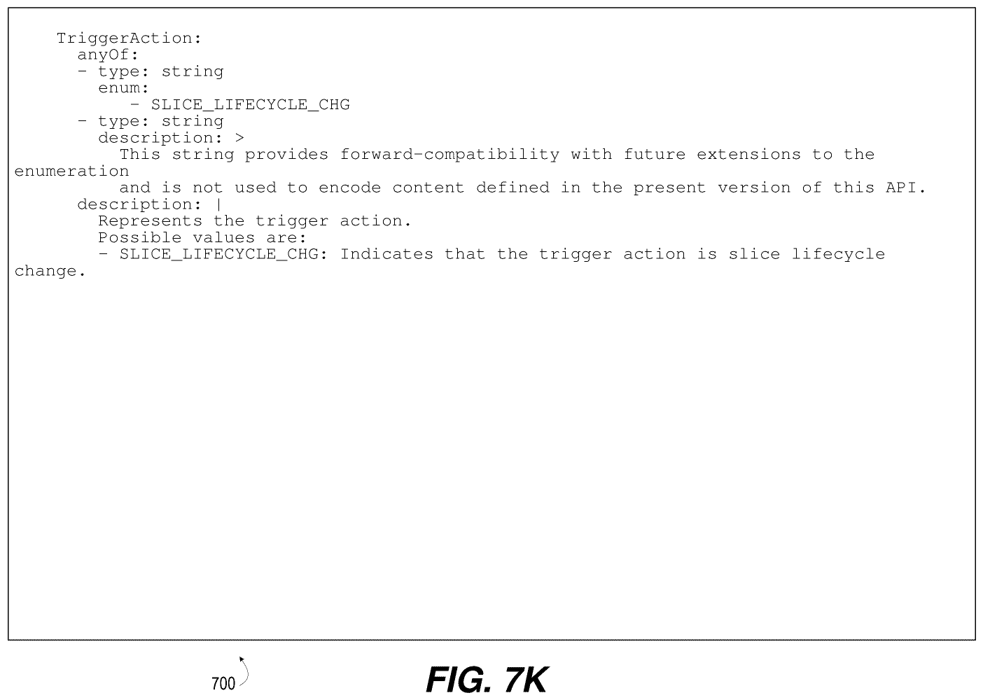

FIGS. 7A-7K (collectively “FIG. 7”) are example program code 700 for the NSCE_ServiceContuity API that includes the custom method for notification of inter EDN slice information in addition to supporting the other Inter-EDN continuity features.

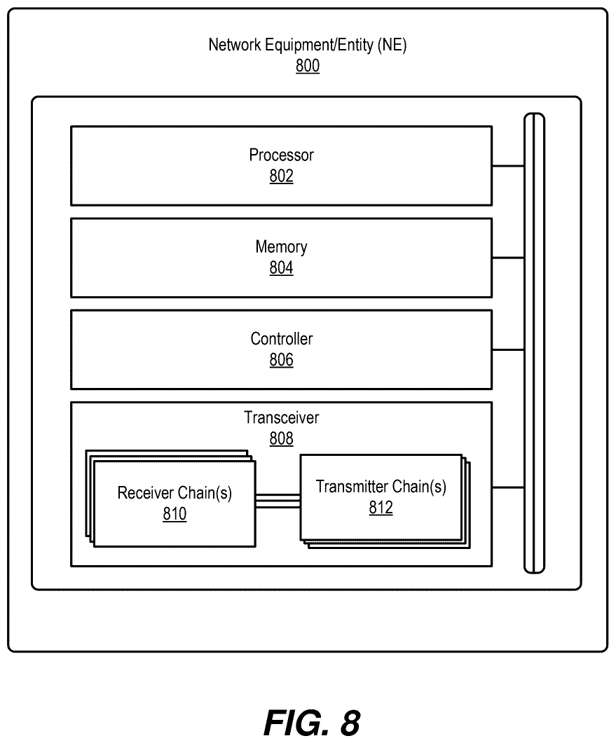

FIG. 8 illustrates an example of a network equipment or network entity (NE) 800 such as a network server in accordance with aspects of the present disclosure. The NE 800 may include a processor 802, a memory 804, a controller 806, and a transceiver 808. The processor 802, the memory 804, the controller 806, or the transceiver 808, or various combinations thereof or various components thereof may be examples of means for performing various aspects of the present disclosure as described herein. These components may be coupled (e.g., operatively, communicatively, functionally, electronically, electrically) via one or more interfaces.

The processor 802, the memory 804, the controller 806, or the transceiver 808, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 802 may include an intelligent hardware device (e.g., a general-purpose processor, a DSP, a CPU, an ASIC, an FPGA, or any combination thereof). In some implementations, the processor 802 may be configured to operate the memory 804. In some other implementations, the memory 804 may be integrated into the processor 802. The processor 802 may be configured to execute computer-readable instructions stored in the memory 804 to cause the NE 800 to perform various functions of the present disclosure.

The memory 804 may include volatile or non-volatile memory. The memory 804 may store computer-readable, computer-executable code including instructions when executed by the processor 802, cause the NE 800 to perform various functions described herein. The code may be stored in a non-transitory computer-readable medium such the memory 804 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 802 and the memory 804 coupled with the processor 802 may be configured to cause the NE 800 to perform one or more of the functions described herein (e.g., executing, by the processor 802, instructions stored in the memory 804). For example, the processor 802 may support wireless communication at the NE 800 in accordance with examples as disclosed herein.

The controller 806 may manage input and output signals for the NE 800. The controller 806 may also manage peripherals not integrated into the NE 800. In some implementations, the controller 806 may utilize an operating system such as iOS®, ANDROID®, WINDOWS®, or other operating systems. In some implementations, the controller 806 may be implemented as part of the processor 802.

In some implementations, the NE 800 may include at least one transceiver 808. In some other implementations, the NE 800 may have more than one transceiver 808. The transceiver 808 may represent a wireless transceiver. The transceiver 808 may include one or more receiver chains 810, one or more transmitter chains 812, or a combination thereof.

A receiver chain 810 may be configured to receive signals (e.g., control information, data, packets) over a wireless medium. For example, the receiver chain 810 may include one or more antennas for receiving the signal over the air or wireless medium. The receiver chain 810 may include at least one amplifier (e.g., a low-noise amplifier (LNA)) configured to amplify the received signal. The receiver chain 810 may include at least one demodulator configured to demodulate the receive signal and obtain the transmitted data by reversing the modulation technique applied during transmission of the signal. The receiver chain 810 may include at least one decoder for decoding and processing the demodulated signal to receive the transmitted data.

A transmitter chain 812 may be configured to generate and transmit signals (e.g., control information, data, packets). The transmitter chain 812 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM).

According to aspects of the present disclosure, the NE 800 operates as a first network entity for wireless communication. In particular, NE 800 operates as an SNSCE server. In response to a mobility of a device, such as a UE, triggering transfer from a source EDN service area to a target EDN service area, processor 802 configures the NE 800 to identify a first network slice associated with the source EDN service area, wherein the first network slice supports a vertical application layer (VAL) service for the device. The processor 802 determines a second network slice associated with the target EDN service area, wherein the second network slice is capable of supporting the VAL service for the device. The processor 802 communicates, to the device, according to a hypertext markup transfer protocol using a custom notify method, a slice configuration associated with the second network slice to maintain a continuity of the VAL service for the device.

In one or more embodiments, the slice configuration is a uniform resource locator (URL) address associated with a notify path. The NE 800 performs as the first network entity that is a service enabler architecture layer network slice capability enablement (SNSCE) server. The device is or includes an SNSCE client. In one or more particular embodiments, the processor 802 receives, from the device, one of: (i) a hypertext markup transfer protocol (HTTP) 204 no content status code from the device; and (ii) a HTTP status respectively indicating success or failure of the device receiving the slice configuration. The processor 802 records in memory 804 an indication of the received HTTP 204 no content status code or the HTTP status code.

In one or more embodiments, the processor 802 communicates with a VAL server using a first application programming interface (API). The processor 802 communicates with the device using a second API. In one or more embodiments, the processor 802 communicates with both of the VAL server and the device using a first API.

In one or more embodiments, the processor 802 determines the mobility of the device indicates impending transfer from the source END service area to the target END service area based on receiving a request from a VAL server associated with the VAL service.

In one or more embodiments, the processor 802 determines whether the first network slice supports a quality of service (QOS) requirement associated with the VAL service from the source END service area. The processor 802 determines the mobility of the device indicates impending transfer from the source END service area to the target END service area based at least in part on determining that the first network slice no longer supports the QoS requirement associated with the VAL service. In response, the processor identifies the second network slice that support the QoS requirement associated with the VAL service.

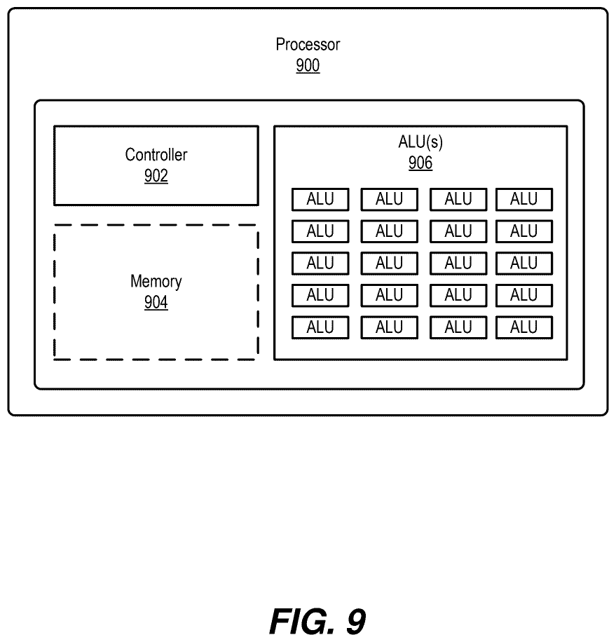

FIG. 9 illustrates an example of a processor 900 in accordance with aspects of the present disclosure. The processor 900 may be an example of a processor configured to perform various operations in accordance with examples as described herein. The processor 900 may include a controller 902 configured to perform various operations in accordance with examples as described herein. The processor 900 may optionally include at least one memory 904, which may be, for example, an L1/L2/L3 cache. Additionally, or alternatively, the processor 900 may optionally include one or more arithmetic-logic units (ALUs) 906. One or more of these components may be in electronic communication or otherwise coupled (e.g., operatively, communicatively, functionally, electronically, electrically) via one or more interfaces (e.g., buses).

The processor 900 may be a processor chipset and include a protocol stack (e.g., a software stack) executed by the processor chipset to perform various operations (e.g., receiving, obtaining, retrieving, transmitting, outputting, forwarding, storing, determining, identifying, accessing, writing, reading) in accordance with examples as described herein. The processor chipset may include one or more cores, one or more caches (e.g., memory local to or included in the processor chipset (e.g., the processor 900) or other memory (e.g., random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), and others).

The controller 902 may be configured to manage and coordinate various operations (e.g., signaling, receiving, obtaining, retrieving, transmitting, outputting, forwarding, storing, determining, identifying, accessing, writing, reading) of the processor 900 to cause the processor 900 to support various operations in accordance with examples as described herein. For example, the controller 902 may operate as a control unit of the processor 900, generating control signals that manage the operation of various components of the processor 900. These control signals include enabling or disabling functional units, selecting data paths, initiating memory access, and coordinating timing of operations.

The controller 902 may be configured to fetch (e.g., obtain, retrieve, receive) instructions from the memory 904 and determine subsequent instruction(s) to be executed to cause the processor 900 to support various operations in accordance with examples as described herein. The controller 902 may be configured to track memory address of instructions associated with the memory 904. The controller 902 may be configured to decode instructions to determine the operation to be performed and the operands involved. For example, the controller 902 may be configured to interpret the instruction and determine control signals to be output to other components of the processor 900 to cause the processor 900 to support various operations in accordance with examples as described herein. Additionally, or alternatively, the controller 902 may be configured to manage flow of data within the processor 900. The controller 902 may be configured to control transfer of data between registers, arithmetic logic units (ALUs), and other functional units of the processor 900.

The memory 904 may include one or more caches (e.g., memory local to or included in the processor 900 or other memory, such RAM, ROM, DRAM, SDRAM, SRAM, MRAM, flash memory, etc. In some implementations, the memory 904 may reside within or on a processor chipset (e.g., local to the processor 900). In some other implementations, the memory 904 may reside external to the processor chipset (e.g., remote to the processor 900).

The memory 904 may store computer-readable, computer-executable code including instructions that, when executed by the (at least one) controller 902, cause the processor 900 to perform various functions described herein. The code may be stored in a non-transitory computer-readable medium such as system memory or another type of memory. The controller 902 and/or the processor 900 may be configured to execute computer-readable instructions stored in the memory 904 to cause the processor 900 to perform various functions. For example, the controller 902 may be coupled with or to the memory 904, and the processor 900, the controller 902, and the memory 904 may be configured to perform various functions described herein. In some examples, the processor 900 may include multiple controllers 902 and the memory 904 may include multiple memories. One or more of the multiple controllers 902 may be coupled with one or more of the multiple memories, which may, individually or collectively, be configured to perform various functions herein.

The one or more ALUs 906 may be configured to support various operations in accordance with examples as described herein. In some implementations, the one or more ALUs 906 may reside within or on a processor chipset (e.g., the processor 900). In some other implementations, the one or more ALUs 906 may reside external to the processor chipset (e.g., the processor 900). One or more ALUs 906 may perform one or more computations such as addition, subtraction, multiplication, and division on data. For example, one or more ALUs 906 may receive input operands and an operation code, which determines an operation to be executed. One or more ALUs 906 be configured with a variety of logical and arithmetic circuits, including adders, subtractors, shifters, and logic gates, to process and manipulate the data according to the operation. Additionally, or alternatively, the one or more ALUs 906 may support logical operations such as AND, OR, exclusive-OR (XOR), not-OR (NOR), and not-AND (NAND), enabling the one or more ALUs 906 to handle conditional operations, comparisons, and bitwise operations.

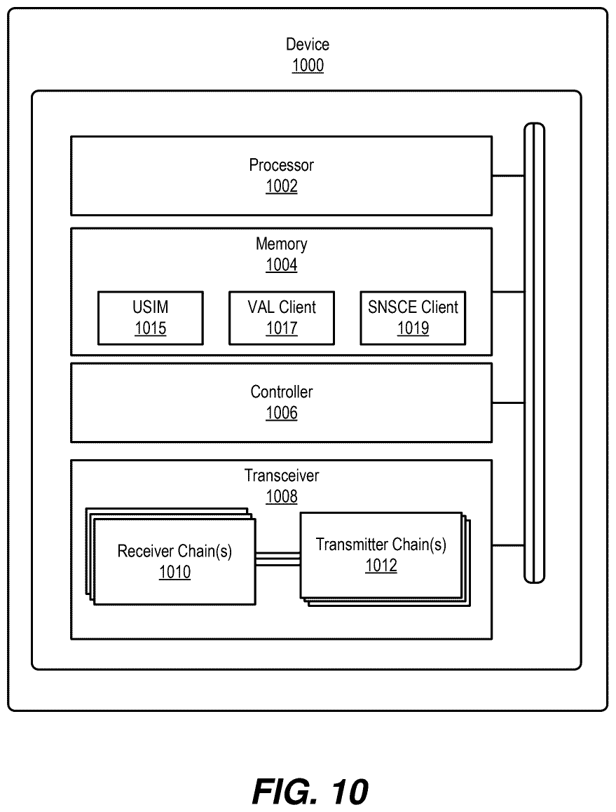

The processor 900 may support wireless communication in accordance with examples as disclosed herein. The processor 900 may be configured to or operable for supporting continuity of a vertical application layer (VAL) service for a device during mobility indicating impending transfer between mobile networks such as Public Land Mobile Networks (PLMN). According to aspects of the present disclosure, in response to a mobility of a device (e.g., device 1000 of FIG. 10) indicating impending transfer from a source network entity to a target network entity, the at least one controller 902 is configured to cause the processor 900 to identify a first network slice associated with the source END service area, where the first network slice supports a VAL service for the device. The at least one controller 902 determines a second network slice associated with the target END service area. The second network slice is capable of supporting the VAL service for the device. The at least one controller 902 communicates, to the device, according to a hypertext markup transfer protocol using a custom notify method, a slice configuration associated with the second network slice to maintain a continuity of the VAL service for the device.

In one or more embodiments, the slice configuration is a uniform resource locator (URL) address associated with a notify path. The first network entity is a service enabler architecture layer network slice capability enablement (SNSCE) server. The device is or includes an SNSCE client.

In one or more embodiments, the controller 902 is configured to cause the processor 900 to receive, from the device, one of: (i) a hypertext markup transfer protocol (HTTP) 204 no content status code from the device; and (ii) a HTTP status respectively indicating success or failure of the device receiving the slice configuration. The controller 902 records in memory 904 an indication of the received HTTP 204 no content status code or the HTTP status code.

In one or more embodiments, the controller 902 is configured to cause the processor 900 to communicate with VAL server using a first application programming interface (API). The controller 902 communicates with the device using a second API. In one or more embodiments, the controller 902 is configured to cause the processor 900 to communicate with both of the VAL server and the device using a first API.

In one or more embodiments, the controller 902 is configured to cause the processor 900 to determine the mobility of the device indicates impending transfer from the source END service area to the target END service area based on receiving a request from a VAL server associated with the VAL service.

In one or more embodiments, the controller 902 is configured to cause the processor 900 to determine whether the first network slice supports a quality of service (QOS) requirement associated with the VAL service from the source END service area. The controller 902 is configured to cause the processor 900 to determine the mobility of the device indicates impending transfer from the source END service area to the target END service area based at least in part on determining that the first network slice does not support of the QOS requirement associated with the VAL service from the target network entity.

FIG. 10 illustrates an example of a device 1000 in accordance with aspects of the present disclosure. The device 1000 may include a processor 1002, a memory 1004, a controller 1006, and a transceiver 1008. The device 1000 may be considered a mobile device that leads to a requirement for inter-EDN mobility. In one or more embodiments, device 1000 is user equipment (UE), having subscriber information stored in memory 1004 that enable access to subscriber services. In an example, memory 1004 includes Universal Subscriber Identity Module (USIM) 1015. Alternatively, or in addition, device 1000 is a client device. In an example, memory 1004 includes vertical application layer (VAL) client 1017 that enables access to a VAL service provided by a VAL server. In another example, memory 1004 includes SNSCE client 1019 that communicates with SNSCE server for continuity of the VAL service during inter-EDN mobility. The processor 1002, the memory 1004, the controller 1006, or the transceiver 1008, or various combinations thereof or various components thereof may be examples of means for performing various aspects of the present disclosure as described herein. These components may be coupled (e.g., operatively, communicatively, functionally, electronically, electrically) via one or more interfaces.

The processor 1002, the memory 1004, the controller 1006, or the transceiver 1008, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 1002 may include an intelligent hardware device (e.g., a general-purpose processor, a DSP, a CPU, an ASIC, an FPGA, or any combination thereof). In some implementations, the processor 1002 may be configured to operate the memory 1004. In some other implementations, the memory 1004 may be integrated into the processor 1002. The processor 1002 may be configured to execute computer-readable instructions stored in the memory 1004 to configure the device 1000 to perform various functions of the present disclosure.

The memory 1004 may include volatile or non-volatile memory. The memory 1004 may store computer-readable, computer-executable code including instructions when executed by the processor 1002, cause the device 1000 to perform various functions described herein. The code may be stored in a non-transitory computer-readable medium, such as the memory 1004 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 1002 and the memory 1004 coupled with the processor 1002 may be configured to cause the device 1000 to perform one or more of the functions described herein (e.g., executing, by the processor 1002, instructions stored in the memory 1004). For example, the processor 1002 may support wireless communication at the device 1000 in accordance with examples as disclosed herein. The device 1000 may be configured to support a means for establishing communication session, such as an IMS session, between originating and terminating user equipment. The controller 1006 may manage input and output signals for the device 1000. The controller 1006 may also manage peripherals not integrated into the device 1000. In some implementations, the controller 1006 may utilize an operating system such as iOS®, ANDROID®, WINDOWS®, or other operating systems. In some implementations, the controller 1006 may be implemented as part of the processor 1002.

In some implementations, the device 1000 may include at least one transceiver 1008. In some other implementations, the device 1000 may have more than one transceiver 1008. The transceiver 1008 may represent a wireless transceiver. The transceiver 1008 may include one or more receiver chains 1010, one or more transmitter chains 1012, or a combination thereof.

A receiver chain 1010 may be configured to receive signals (e.g., control information, data, packets) over a wireless medium. For example, the receiver chain 1010 may include one or more antennas for receiving the signal over the air or wireless medium. The receiver chain 1010 may include at least one amplifier (e.g., a low-noise amplifier (LNA)) configured to amplify the received signal. The receiver chain 1010 may include at least one demodulator configured to demodulate the receive signal and obtain the transmitted data by reversing the modulation technique applied during transmission of the signal. The receiver chain 1010 may include at least one decoder for decoding and processing the demodulated signal to receive the transmitted data.

A transmitter chain 1012 may be configured to generate and transmit signals (e.g., control information, data, packets). The transmitter chain 1012 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 1012 may also include at least one power amplifier configured to amplify the modulated signal to an appropriate power level suitable for transmission over the wireless medium. The transmitter chain 1012 may also include one or more antennas for transmitting the amplified signal into the air or wireless medium. In one or more aspects of the present disclosure, the device 1000 performs wireless communication including improved delay status reporting for flexible measurement period cancellation.

According to aspects of the present disclosure, the at least one processor 1002 is configured to cause the device 1000 to communicate with a source EDN service area to receive a vertical application layer (VAL) service supported by a first network slice. The at least one processor 1002 is configured to cause the device 1000 to receive, from a first network entity, such as NE 800 (FIG. 8) according to a hypertext markup transfer protocol using a custom notify method, a slice configuration associated with a second network slice to maintain continuity of the VAL service for the device. The at least one processor 1002 is configured to cause the device 1000 to perform a transfer to a target EDN service area. The at least one processor 1002 is configured to cause the device 1000 to communicate with the target EDN service area using the slice configuration of the second network slice to receive the VAL service supported by the second network slice.

In one or more embodiments, the first network entity is a service enabler architecture layer network slice capability enablement (SNSCE) server. The device is or includes an SNSCE client.

In one or more embodiments, the at least one processor 1002 is configured to cause the device 1000 to determine whether the slice configuration is successfully received. the at least one processor 1002 is configured to cause the device 1000 to communicate, via the source EDN service area to the first network entity, a hypertext markup transfer protocol (HTTP) 204 no content status code, in response to determining that the slice configuration is successfully received.

In one or more embodiments, the at least one processor 1002 is configured to cause the device 1000 to determine whether the slice configuration is successfully received. The at least one processor 1002 is configured to cause the device 1000 to communicate, via the source network entity (e.g., base station supporting the source EDN service area) to the first network entity (e.g., source SNSCE server), a hypertext markup transfer protocol (HTTP) status code indicating failure, in response to determining that the slice configuration is not successfully received.

In one or more embodiments, the at least one processor 1002 is configured to cause the device 1000 to communicate, via the source edge data network service area, using a first application programming interface (API) with a vertical application layer server that supports the vertical application layer service. The at least one processor 1002 is configured to cause the device 1000 to communicate, via the source network entity, with the first network entity using a second API.

In one or more embodiments, the at least one processor 1002 is configured to cause the device 1000 to communicate, via the source EDN service area, using a first API, with both of a vertical application layer server that supports the vertical application layer service and the first network entity.

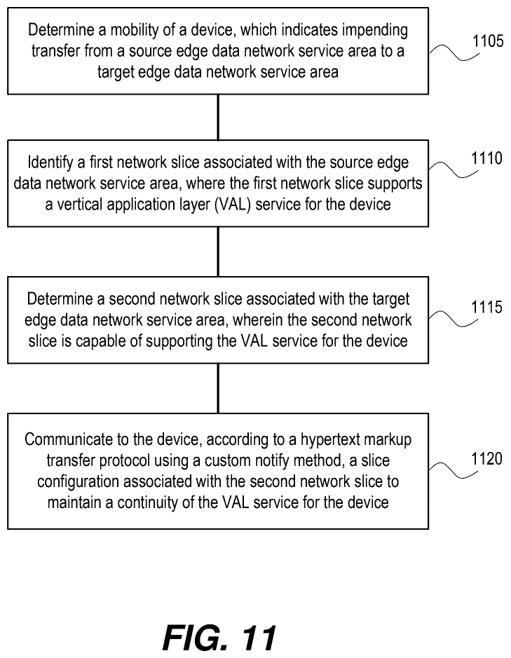

FIG. 11 illustrates a flowchart of a method for wireless communication at a network in accordance with aspects of the present disclosure. The operations of the method may be implemented by a network entity (NE) such as a server as described herein. In some implementations, the NE may execute a set of instructions to control the functional elements of the NE to perform the described functions.

At 1105, the method may include determining a mobility of a device, which indicates impending transfer from a source edge data network service area to a target edge data network service area. The operations of 1105 may be performed in accordance with examples as described herein. In some implementations, aspects of the operations of 1105 may be performed by a NE as described with reference to FIG. 8.

At 1110, the method may include identifying a first network slice associated with the source edge data network service area, wherein the first network slice supports a vertical application layer (VAL) service for the device. The operations of 1110 may be performed in accordance with examples as described herein. In some implementations, aspects of the operations of 1110 may be performed by a NE as described with reference to FIG. 8.

At 1115, the method may include determining a second network slice associated with the target edge data network service area, where the second network slice is capable of supporting the VAL service for the device. The operations of 1115 may be performed in accordance with examples as described herein. In some implementations, aspects of the operations of 1115 may be performed by a NE as described with reference to FIG. 8.

At 1120, the method may include communicating to the device, according to a hypertext markup transfer protocol using a custom notify method, a slice configuration associated with the second network slice to maintain a continuity of the VAL service for the device. The operations of 1120 may be performed in accordance with examples as described herein. In some implementations, aspects of the operations of 1120 may be performed by a NE as described with reference to FIG. 8.

In accordance with an aspect of the present disclosure, the slice configuration is a uniform resource locator (URL) address associated with a notify path. The method may further include communicating with a second network entity in the target edge data network service area to determine the second network slice. In one or more particular embodiments, the first network entity is or includes a service enabler architecture layer network slice capability enablement (SNSCE) server in the source edge data network service area. The second network entity is an SNSCE server in the target edge data network service area. The device is or includes an SNSCE client.

In one or more particular embodiments, the method may further include receiving, from the device, one of: (i) a hypertext markup transfer protocol (HTTP) 204 no content status code from the device; and (ii) a HTTP status respectively indicating success or failure of the device receiving the slice configuration. The method may further include recording an indication of the received HTTP 204 no content status code or the HTTP status code.

In one or more embodiments, the method may further include communicating, using a first application programming interface (API), with a VAL server that supports the VAL service. The method may further include communicating, using a second API, with the device. In one or more alternative embodiments, the method may further include communicating, using a first API, with the VAL server and the device.

In one or more embodiments, the method may further include determining the mobility of the device indicates impending transfer from the source edge data network service area to the target edge data network service area based on receiving a request from a VAL server associated with the VAL service. In one or more alternative embodiments, the method may further include determining whether the first network slice supports a quality of service (QoS) requirement associated with the VAL service from the source edge data network service area. The method may further include determining the mobility of the device indicates impending transfer from the source edge data network service area to the target edge data network service area based at least in part on determining that the first network slice does not support of the QoS requirement associated with the VAL service.

In accordance with another aspect of the present disclosure, the method may include determining by a first network entity, lack of availability and good condition of a first network slice at a second network entity. The first network slice is required for a VAL application at the first network entity and the first network slice cannot be used for the VAL application at a second network entity. The method may further include negotiating by the first network entity with the second network entity to determine a second network slice for the VAL application at the second network entity. The method may include using an HTTP method by the first network entity to transmit a second network slice to a device moving from the first network entity to the second network entity, where the HTTP method is a custom method “Notify” with a path “/notify”.

In one or more embodiments, the HTTP custom method uses HTTP POST request with HTTP 204 No content as a successful response. In one or more embodiments, the first entity is an SNSCE server in source EDN service area. The second network entity is an SNSCE server in target EDN service area. The device is an SNSCE client. In one or more embodiments, the first network entity for the custom method uses a new API or the same API used when communicating with a VAL server as when communicating with the device. In one or more embodiments, the network slice is modified and replaced to maintain the VAL service continuity in the second network entity.

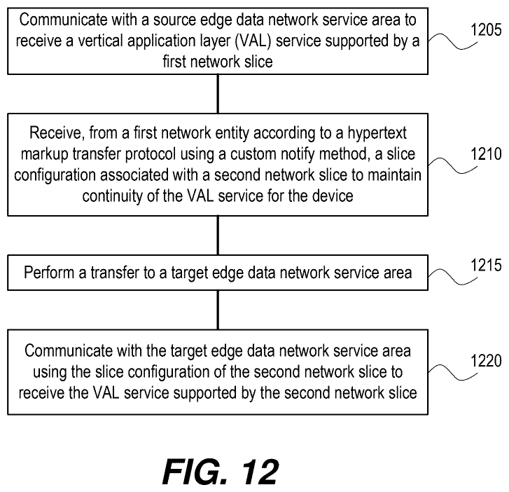

FIG. 12 illustrates a flowchart of a method for wireless communication at device, such as a user equipment (UE), in accordance with aspects of the present disclosure. The operations of the method may be implemented by device as described herein. In some implementations, the device may execute a set of instructions to control the function elements of the device to perform the described functions.

At 1205, the method may include communicating with a source edge data network service area to receive a vertical application layer (VAL) service supported by a first network slice. The operations of 1205 may be performed in accordance with examples as described herein. In some implementations, aspects of the operations of 1205 may be performed by a device as described with reference to FIG. 10.

At 1210, the method may include receiving, from a first network entity according to a hypertext markup transfer protocol using a custom notify method, a slice configuration associated with a second network slice to maintain continuity of the VAL service for the device. The operations of 1210 may be performed in accordance with examples as described herein. In some implementations, aspects of the operations of 1210 may be performed by a device as described with reference to FIG. 10.

At 1215, the method may include performing a transfer to a target edge data network service area. The operations of 1215 may be performed in accordance with examples as described herein. In some implementations, aspects of the operations of 1215 may be performed by a device as described with reference to FIG. 10.

At 1220, the method may include communicating with the target edge data network service area using the slice configuration of the second network slice to receive the VAL service supported by the second network slice. The operations of 1220 may be performed in accordance with examples as described herein. In some implementations, aspects of the operations of 1220 may be performed by a device as described with reference to FIG. 10.

In one or more embodiments, the method may further include determining whether the slice configuration is successfully received. The method may further include communicating, via the source edge data network service area to the first network entity, a hypertext markup transfer protocol (HTTP) 204 no content status code in response to determining that the slice configuration is successfully received.

In one or more embodiments, the method may further include determining whether the slice configuration is successfully received. The method may further include communicating, via the source edge data network service area to the first network entity, an HTTP status code indicating failure in response to determining that the slice configuration is not successfully received.

In one or more embodiments, the method may further include communicating, via the source edge data network service area, using a first application programming interface (API) with a vertical application layer server that supports the vertical application layer service. The method may further include communicating, via the source network entity, with the first network entity using a second API. In one or more alternative embodiments, the method may further include communicating, via the source network entity, using a first API, with both of a vertical application layer server that supports the vertical application layer service and the first network entity.

It should be noted that the method described herein describes a possible implementation, and that the operations and the steps may be rearranged or otherwise modified and that other implementations are possible.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A first network entity for wireless communication, the first network entity comprising:
at least one memory; and
at least one processor coupled with the at least one memory and configured to cause the first network entity to:
in response to a mobility of a device indicating impending transfer from a source edge data network service area supported by the first network entity to a target edge data network service area:
identify a first network slice associated with the source edge data network service area, wherein the first network slice supports a vertical application layer (VAL) service for the device;
determine a second network slice associated with the target edge data network service area, wherein the second network slice is capable of supporting the VAL service for the device; and
communicate, to the device, according to a hypertext markup transfer protocol using a custom notify method, a slice configuration associated with the second network slice to maintain a continuity of the VAL service for the device.

2. The first network entity of claim 1, wherein:
the slice configuration comprises a uniform resource locator (URL) address associated with a notify path, and the at least one processor is configured to cause the first network entity to:
communicate with a second network entity in the target edge data network service area to determine the second network slice.

3. The first network entity of claim 2, wherein:
the first network entity comprises a source service enabler architecture layer network slice capability enablement (SNSCE) server in the source edge data network service area;
the second network entity comprises a target SNSCE server in the target edge data network service area; and
the device comprises an SNSCE client.

4. The first network entity of claim 1, wherein the at least one processor is configured to cause the first network entity to:
receive, from the device, one of: (i) a hypertext markup transfer protocol (HTTP) 204 no content status code; or (ii) a HTTP status code respectively indicating success or failure of the device receiving the slice configuration; and
record an indication of the received one of the HTTP no content status code or the HTTP status code.

5. The first network entity of claim 1, wherein the at least one processor is configured to cause the first network entity to:
communicate using a first application programming interface with a vertical application layer server that supports the vertical application layer service (API); and
communicate with the device using a second API.

6. The first network entity of claim 1, wherein the at least one processor is configured to cause the first network entity to:
communicate using a first application programming interface (API), with both the device and a vertical application layer server associated with the vertical application layer service.

7. The first network entity of claim 1, wherein the at least one processor is configured to cause the first network entity to:
determine the mobility of the device indicates impending transfer from the source edge data network service area to the target edge data network service area based on receiving a request from a VAL server that provides the VAL service.

8. The first network entity of claim 1, wherein the at least one processor is configured to cause the first network entity to:
determine whether the first network slice supports a quality of service (QOS) requirement associated with the VAL service; and
determine the mobility of the device indicates impending transfer from the source edge data network service area to the target edge data network service area based at least in part on determining that the first network slice does not support the QoS requirement associated with the VAL service.

9. A processor for wireless communication at a first network entity, the processor comprising:
at least one controller coupled with at least one memory and configured to cause the processor to:
in response to a mobility of a device indicating impending transfer from a source edge data network service area supported by the first network entity to a target edge data network service area:
identify a first network slice associated with the source edge data network service area, wherein the first network slice supports a vertical application layer (VAL) service for the device;
determine a second network slice associated with the target edge data network service area, wherein the second network slice is capable of supporting the VAL service for the device; and
communicate, according to a hypertext markup transfer protocol using a custom notify method, a slice configuration associated with the second network slice to maintain continuity of the VAL service for the device.

10. A method for wireless communication at a first network entity, the method comprising:
in response to a mobility of a device indicating impending transfer from a source edge data network service area supported by the first network entity to a target edge data network service area:
identifying a first network slice associated with the source edge data network service area, wherein the first network slice supports a vertical application layer (VAL) service for the device;
determining a second network slice associated with the target edge data network service area, wherein the second network slice is capable of supporting the VAL service for the device; and
communicating, according to a hypertext markup transfer protocol using a custom notify method, a slice configuration associated with the second network slice to maintain a continuity of the VAL service for the device.

11. The method of claim 10, wherein communicating the slice configuration comprises a uniform resource locator (URL) address associated with a notify path, and the method further comprises:
communicating with a second network entity in the target edge data network service area to determine the second network slice.

12. The method of claim 11, wherein:
the first network entity comprises a source service enabler architecture layer network slice capability enablement (SNSCE) server in the source edge data network service area;
the second network entity comprises a target SNSCE server in the target edge data network service area; and
the device comprises an SNSCE client.

13. The method of claim 10, further comprising:
receiving one of: (i) a hypertext markup transfer protocol (HTTP) 204 no content status code; or (ii) a HTTP status code respectively indicating success or failure of the device receiving the slice configuration; and
recording an indication of the received one of the HTTP no content status code or the HTTP status code.

14. The method of claim 10, further comprising:
determining the mobility of the device indicates impending transfer from the source edge data network service area to the target edge data network service area based on receiving a request from a VAL server that provides the VAL service.

15. The method of claim 10, further comprising:
determining whether the first network slice supports a quality of service (QOS) requirement associated with the VAL service; and
determining the mobility of the device indicates impending transfer from the source edge data network service area to the target edge data network service area based at least in part on determining that the first network slice does not support the QoS requirement associated with the VAL service.

16. A device for wireless communication, the device comprising:
at least one memory; and
at least one processor coupled with the at least one memory and configured to cause the device to:
communicate with a source edge data network service area to receive a vertical application layer (VAL) service supported by a first network slice; and
receive, from a first network entity according to a hypertext markup transfer protocol using a custom notify method, a slice configuration associated with a second network slice to maintain a continuity of the VAL service for the device;
perform a transfer to a target edge data network area; and
communicate with the target edge data network area using the slice configuration to receive the VAL service supported by the second network slice.

17. The device of claim 16, wherein:
the slice configuration comprises a uniform resource locator (URL) address associated with a notify path;
the first network entity comprises a source service enabler architecture layer network slice capability enablement (SNSCE) server in the source edge data network service area;
the at least one memory comprises an SNSCE client; and
the at least one processor is configured to cause the device to communicate, via the target edge data network service area, with a second network entity comprising a target SNSCE server in the target edge data network service area to maintain VAL service continuity subsequent to performing the transfer to the target edge data network area.

18. The device of claim 16, wherein the at least one processor is configured to cause the device to:
determine whether the slice configuration is successfully received; and
communicate, via the source edge data network service area to the first network entity, a hypertext markup transfer protocol (HTTP) 204 no content status code in response to determining that the slice configuration is successfully received.

19. The device of claim 16, wherein the at least one processor is configured to cause the device to:
determine whether the slice configuration is successfully received; and
communicate, via the source edge data network service area to the first network entity, a hypertext markup transfer protocol (HTTP) status code indicating failure in response to determining that the slice configuration is not successfully received.

20. The device of claim 16, wherein the at least one processor is configured to cause the device to:
communicate, via the source edge data network service area, using a first application programming interface (API) with a vertical application layer server that supports the vertical application layer service; and
communicate, via the source edge data network service area, with the first network entity using a second API.
